(19) United States
(12) Patent Application Publication
(10) Pub. No.: US 2008/0129520 A1
(43) Pub. Date: Jun. 5, 2008

(54) ELECTRONIC DEVICE WITH ENHANCED AUDIO FEEDBACK

(75) Inventor: Michael M. Lee, San Jose, CA (US)

Correspondence Address: BEYER LAW GROUP LLP/APPLE INC., P.O. BOX 1687, CUPERTINO, CA, 95015-1687, US

(73) Assignee: APPLE COMPUTER, INC., Cupertino, CA (US)

(21) Appl. No.: 11/565,830

(22) Filed: Dec. 1, 2006

(51) Int. Cl. G08B 21/00

(52) U.S. Cl. 340/636.1

(57) ABSTRACT

An electronic device that provides audio feedback is disclosed. The audio feedback can assist a user with usage of the electronic device. Audio characteristics of the audio feedback can pertain to one or more events or condition associated with the electronic device. The events or conditions can vary depending on the nature of the electronic device. The electronic device is, for example, a portable electronic device, such as a media device (e.g., media playback device).

### CROSS-REFERENCE TO RELATED APPLICATIONS

This application is related to: (i) U.S. patent application Ser. No. 11/144,541, filed Jun. 3, 2005, and entitled “TECHNIQUES FOR PRESENTING SOUND EFFECTS ON A PORTABLE MEDIA PLAYER” [Att.Dkt.No.: APL1 P392], which is hereby incorporated herein by reference; and (ii) U.S. patent application Ser. No. 11/209,367, filed Aug. 22, 2005, and entitled “AUDIO STATUS INFORMATION FOR A PORTABLE ELECTRONIC DEVICE” [Att.Dkt.No.: APL1 P395], which is hereby incorporated herein by reference.

### BACKGROUND OF THE INVENTION

1. Field of the Invention

The present invention relates to electronic devices and, more particularly, to providing audio feedback on a portable electronic device.

2. Description of the Related Art

Conventionally, portable electronic devices, such as cellular phones, portable digital assistants or portable media players, have provided visual clues regarding certain device status conditions. For example, battery-powered portable electronic devices frequently display a visual indication of battery status. The visual indication typically indicates the extent to which the battery is charged (i.e., battery level). However, users often interact with portable media players while wearing earphones, headphones or headset. For example, users might also use portable media players to listen to audio sounds via the earphones or headphones. In such cases, the users will likely not be able or interested to view a display screen that displays a visual indication of battery level. Still further, some portable media players do not even include a display screen. Consequently, any device status being displayed will conventionally not likely be received by the user of the portable media player.

Portable electronic devices can also provide visual and audio feedback with regard to user interaction with the portable electronic devices. One example of conventional audio feedback is the output of a “click” sound in response to a user input with the portable electronic device, namely, a portable media player. For example, the “click” sound can signal the user that a user interaction (button press, scroll action, etc.) has been received. The conventional “click” sound is static. In one embodiment, the “click” sound can be produced by a piezoelectric device provided within the housing of portable electronic player. See U.S. Patent Publications Nos. 2003/0076301 A1 and 2003/0095096 A1. Another example of conventional audio feedback is that some cellular phones can not only provide such a visual indication of battery level but also provide an auditory, periodic beeping sound during a call in process to alert the user when battery level is particularly low.

Unfortunately, however, users of portable media players often do not have the ability to visualize or see the graphical user interface being presented on the display. For example, a user may be involved in an activity that does not easily permit the user to view the display of the portable media player. As another example, the portable media player may be within a pocket of the user and otherwise not immediately viewable by the user. Still further, the user may be visually impaired so that the display is of limited or no use. Hence, there is a need for improved ways to assist a user of a portable media player to more easily understand navigation effects as well as battery conditions, even when the user is unable or unwilling to visualize a display associated with the portable media player.

Thus, there is a need for improved techniques to produce audio feedback to inform users about device operation and/or status of portable media players.

### SUMMARY OF THE INVENTION

The invention pertains to an electronic device that provides audio feedback. The audio feedback can assist a user with usage of the electronic device. Audio characteristics of the audio feedback can pertain to one or more events or condition associated with the electronic device. The events or conditions can vary depending on the nature of the electronic device. The electronic device is, for example, a portable electronic device, such as a media device (e.g., media playback device).

The invention can be implemented in numerous ways, including as a method, system, device, apparatus (including graphical user interface), or computer readable medium. Several embodiments of the invention are discussed below.

As a method for providing audio feedback to a user of an electronic device having a display and a user input device, one embodiment of the invention includes at least: receiving a user input via the user input device; setting at least one audio characteristic for audio feedback; and presenting audio feedback responsive to the user input.

As a method for providing audio feedback to a user of an electronic device having a display and a user input device, one embodiment of the invention includes at least: receiving a user input pertaining to a menu navigation event with respect to a user interface presented on the display; modifying an audio characteristic for audio feedback depending on the menu navigation event; updating the user interface presented on the display based on the menu navigation event; thereafter receiving a user input pertaining to a scroll event with respect to the user interface presented on the display; updating the user interface presented on the display based on the scroll event; and presenting audio feedback responsive to the user input pertaining to the scroll event, the audio feedback being presented in accordance with the audio characteristic.

As a method for providing audio feedback to a user of an electronic device having a display and a user input device, one embodiment of the invention includes at least: receiving a user input pertaining to a scroll event with respect to a user interface presented on the display; modifying an audio characteristic for audio feedback in response to the scroll event; updating the user interface presented on the display based on the scroll event; and presenting audio feedback responsive to the user input pertaining to the scroll event, the audio feedback being presented in accordance with the audio characteristic.

As a method for providing audio feedback to a user of an electronic device being powered by a battery, one embodiment of the invention includes at least: obtaining battery status pertaining to the battery; and setting an audio characteristic for battery status feedback based on the battery status.

As a computer readable medium including at least computer program code for providing audio feedback to a user of an electronic device having a display and a user input device, one embodiment of the invention includes at least: computer program code for receiving a user input via the user input device; computer program code for setting at least one audio characteristic for audio feedback; and computer program code for presenting audio feedback responsive to the user input.

As a computer readable medium including at least computer program code for providing audio feedback to a user of an electronic device being powered by a battery, one embodiment of the invention includes at least: computer program code for obtaining battery status pertaining to the battery; and computer program code for setting an audio characteristic for battery status feedback based on the battery status.

As a portable media device, one embodiment of the invention includes at least: an audio output device; an electronic device used by the portable media player; a monitor that monitors a condition of the portable media player; and an audio feedback manager operatively connected to the monitor. The audio feedback manager causes an audio characteristic of audio feedback to be modified based on the condition of the portable media device, and determines when the audio feedback is to be output to the audio output device in accordance with the audio characteristic.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of an audio feedback process according to one embodiment of the invention.

FIG. 2 is a flow diagram of an audio feedback process according to another embodiment of the invention.

FIG. 3 is a flow diagram of a scroll input process according to one embodiment of the invention.

FIG. 4 is a flow diagram of a navigation/scroll input process according to one embodiment of the invention.

FIG. 5A is a graph depicting an exemplary relationship of tone frequency to list depth according to one embodiment of the invention.

FIG. 5B is a graph depicting tone frequency with respect to menu level according to one embodiment of the invention.

FIG. 6 is a flow diagram of an audio feedback process according to one embodiment of the invention.

FIG. 7 is a flow diagram of an audio feedback process according to another embodiment of the invention.

FIG. 8A is an exemplary graph of loudness versus charge level according to one embodiment of the invention.

FIG. 8B is a graph of tone frequency versus charge level according to one embodiment of the invention.

FIG. 9 is a flow diagram of an audio feedback process according to another embodiment of the invention.

FIG. 10 is a block diagram of a media player according to one embodiment of the invention.

FIG. 11 illustrates a media player having a particular user input device according to one embodiment.

### DETAILED DESCRIPTION OF THE INVENTION

The invention pertains to an electronic device that provides audio feedback. The audio feedback can assist a user with usage of the electronic device. Audio characteristics of the audio feedback can pertain to one or more events or condition associated with the electronic device. The events or conditions can vary depending on the nature of the electronic device. As one example, where the electronic device has a display, the electronic device can provide audio feedback for menu navigation events. An electronic device can also provide audio feedback for scroll events. As another example, where the electronic device is battery-powered, one condition of the electronic device that can be monitored is a battery charge level. The audio feedback can be output to an audio output device associated with the electronic device. The electronic device is, for example, a portable electronic device, such as a media device (e.g., media playback device).

The invention is well suited for electronic devices that are portable. The ability to provide a user with event or condition information through audio feedback avoids the need for a user to view a display screen to obtain event or condition information. Furthermore, event or condition information can also be provided even when the electronic device does not have a display screen.

The improved techniques are also well suited for use with portable electronic devices having audio playback capabilities, such as portable media devices (e.g., digital music player or MP3 player). Portable media devices can store and play media assets (media items), such as music (e.g., songs), videos (e.g., movies), audiobooks, podcasts, meeting recordings, and other multimedia recordings. Portable media devices, such as media players, are small and highly portable and have limited processing resources. Often, portable media devices are hand-held media devices, such as hand-held media players, which can be easily held by and within a single hand of a user. Portable media devices can also be pocket-sized, miniaturize or wearable.

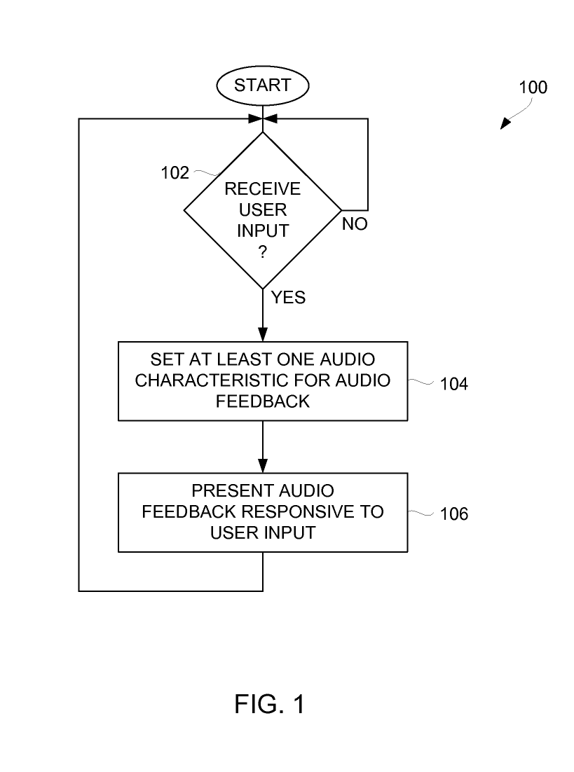

Embodiments of the invention are discussed below with reference to FIGS. 1-11. However, those skilled in the art will readily appreciate that the detailed description given herein with respect to these figures is for explanatory purposes as the invention extends beyond these limited embodiments.

One aspect of the invention makes use of audio feedback to assist a user with non-visual interaction with an electronic device. The audio feedback can provide, for example, information to a user in an audio manner so that the user is able to successfully interact with the electronic device without having to necessarily view a Graphical User Interface (GUI).

FIG. 1 is a flow diagram of an audio feedback process 100 according to one embodiment of the invention. The audio feedback process 100 is, for example, performed by an electronic device having a user input device and a display capable of presenting a graphical user interface (GUI). The electronic device is capable of providing audio feedback to a user.

The audio feedback process 100 begins with a decision 102. The decision 102 determines whether a user input has been received. The user input can be received via the user input device associated with the electronic device. When the decision 102 determines that a user input has not been received, then the audio feedback process 100 awaits a user input. On the other hand, when the decision 102 determines that a user input has been received, the audio feedback process 100 continues. In other words, the audio feedback process 100 can be deemed to be invoked when a user input is received.

In any event, when the decision 102 determines that a user input has been received, at least one audio characteristic for audio feedback can be set 104. The audio characteristic can pertain to any characteristic that affects the audio output sound for the audio feedback. For example, the audio characteristic can pertain to: frequency, loudness, repetitions, duration, pitch, etc. In one implementation, at least one audio characteristic for the audio feedback can be set 104 based on the user input received. For example, the user input received can pertain to a user interaction with respect to a graphical user interface being presented on the display. The audio characteristic can be set 104 dependent upon the user's position or interaction with respect to the graphical user interface.

After at least one audio characteristic for the audio feedback has been set 104, the audio feedback can be presented 106 responsive to the user input. In this embodiment, the audio feedback is responsive to the user input. In other words, the audio feedback can provide an audio indication to the user of the electronic device that the user input has been received and/or accepted. The specific nature of the audio sound can vary widely depending upon implementation. As one specific example, the audio sound can pertain to a “click” or “tick” sound.

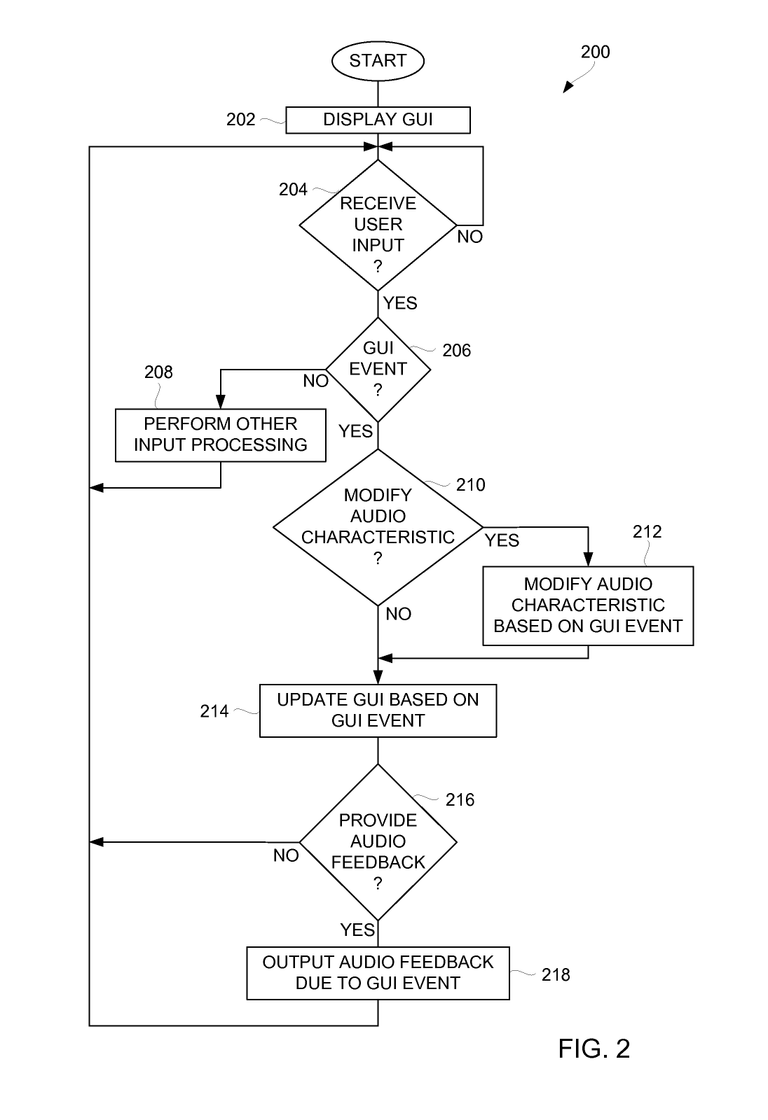

FIG. 2 is a flow diagram of an audio feedback process 200 according to another embodiment of the invention. The audio feedback process 200 is, for example, performed by an electronic device having a user input device and a display capable of presenting a graphical user interface (GUI). The electronic device is capable of providing audio feedback to a user.

The audio feedback process 200 initially displays 202 a graphical user interface (GUI). Then, a decision 204 determines whether a user input has been received. When the decision 204 determines that a user input has not been received, the audio feedback process 200 awaits a user input. Once the decision 204 determines that a user input has been received, a decision 206 determines whether the user input pertains to a GUI event. When the decision 206 determines that the user input does not pertain to a GUI event, other input processing is performed 208. Such other processing can vary widely depending on implementation.

On the other hand, when the decision 206 determines that the user input pertains to a GUI event, a decision 210 determines whether an audio characteristic is to be modified. The audio characteristic can pertain to any characteristic that affects the audio output sound for the audio feedback. For example, the audio characteristic can pertain to: frequency, loudness, repetitions, duration, pitch, etc. When the decision 210 determines that an audio characteristic is to be modified, the audio characteristic is modified 212 based on the GUI event. Alternatively, the block 212 is bypassed when the decision 210 determines that an audio characteristic is not to be modified. Following the block 212 or directly following the decision 210 when an audio characteristic is not being modified, the GUI is updated 214 based on the GUI event. Next, a decision 216 determines whether audio feedback is to be provided. When the decision 216 determines that audio feedback is to be provided, audio feedback due to the GUI event is output 218. Here, the audio feedback being output 218 is provided in accordance with the audio characteristic that has been modified 212. Following the block 218 or directly following the decision 216 when audio feedback is not to be provided, the audio feedback process 200 can return to repeat the decision 204 and subsequent blocks so that subsequent user inputs can be similarly processed.

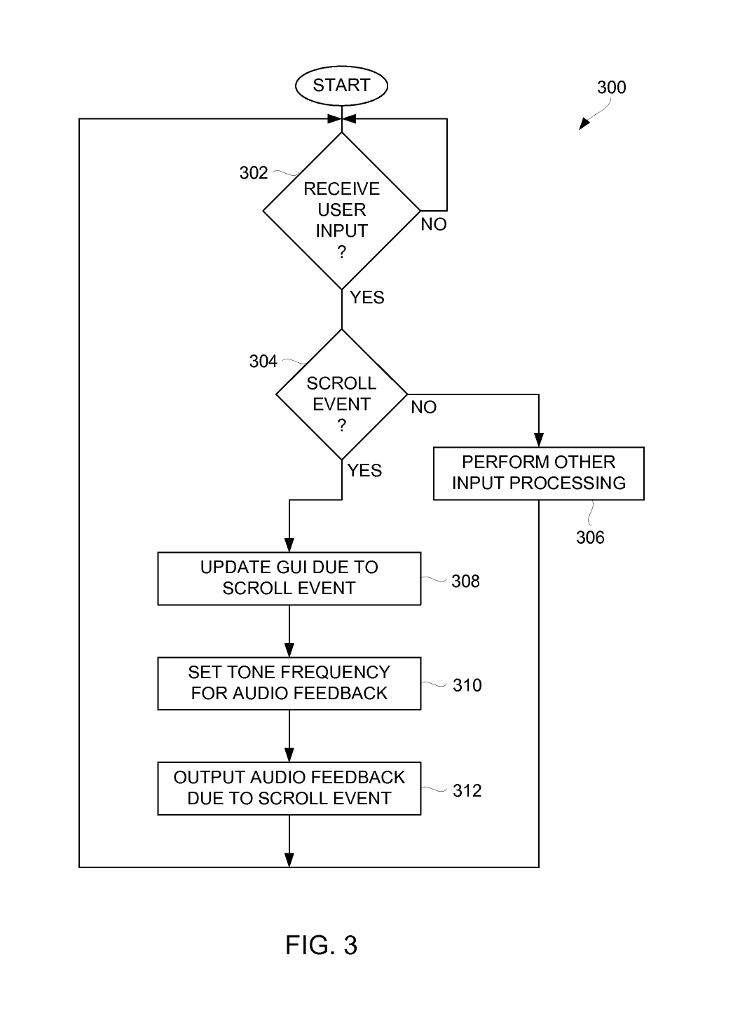

FIG. 3 is a flow diagram of a scroll input process 300 according to one embodiment of the invention. The scroll input feedback process 300 is, for example, performed by an electronic device having a user input device and a display capable of presenting a graphical user interface (GUI). The electronic device is capable of providing audio feedback to a user.

The scroll input process 300 begins with a decision 302. The decision 302 determines whether a user input has been received. When the decision 302 determines that a user input has not been received, the scroll input process 300 awaits a user input. Once the decision 302 determines that a user input has been received, the scroll input process 300 can continue. In other words, the scroll input process 300 can be deemed invoked when a user input is received.

Once the decision 302 determines that a user input has been received, a decision 304 determines whether the user input pertains to a scroll event. When the decision 304 determines that the user input does not pertain to a scroll event, other input processing can be performed 306. The other input processing can, for example, be for a navigation event, a selection event, a status request, an application/function activation, etc.

On the other hand, when the decision 304 determines that the user input does pertain to a scroll event, a graphical user interface (GUI) is updated 308 due to the scroll event. In addition, a tone frequency for audio feedback is set 310. In one implementation, the tone frequency for audio feedback is set 310 relative to a pointer position with respect to a list that is being scrolled by the scroll event. After the tone frequency for audio feedback has been set 310, audio feedback due to the scroll event is output 312. The audio feedback is output 312 in accordance with the tone frequency that has been set 310. As an example, the tone frequency for the audio feedback can indirectly inform the user of the relative position within a list being displayed by the GUI. In one implementation, the audio feedback can be output 312 from an audio output device (e.g., speaker) within or coupled to the electronic device. Following the blocks 306 and 312, the scroll input process 300 can return to repeat the decision 302 so that additional user inputs can be similarly processed.

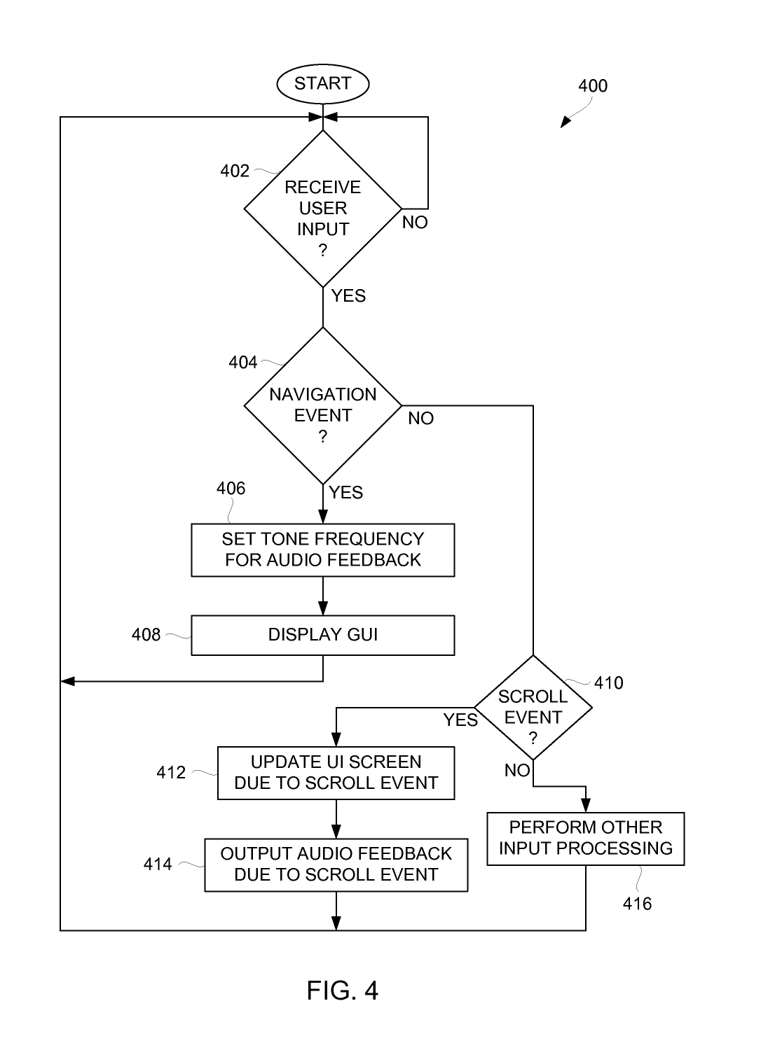

FIG. 4 is a flow diagram of a navigation/scroll input process 400 according to one embodiment of the invention. The navigation/scroll input process 400 is, for example, performed by an electronic device having a user input device and a display capable of presenting a graphical user interface (GUI). The electronic device is capable of providing audio feedback to a user.

The navigation/scroll input process 400 begins with a decision 402. The decision 402 determines whether a user input has been received. When the decision 402 determines that a user input has not been received, the navigation/scroll input process 400 awaits a user input. Once the decision 402 determines that a user input has been received, the navigation/scroll input process 400 can continue. In other words, the navigation/scroll input process 400 can be deemed to be invoked when a user input is received.

In any case, once a user input has been received, a decision 404 determines whether the user input pertains to a navigation event. When the decision 404 determines that the user input does pertain to a navigation event, a tone frequency for audio feedback is set 406. In addition, a graphical user interface (GUI) can be displayed 408. The GUI can be displayed 408 by presenting a UI screen on the display of the electronic device. The GUI being displayed 408 can be newly presented or updated with respect to a prior user interface screen presented on the display. For example, in one embodiment, the GUI can pertain to a menu in a hierarchical menu system. Hence, the navigation event can pertain to navigation from one menu to a different menu of the plurality of menus within the hierarchical menu system. In one implementation, the tone frequency for audio feedback being set 406 can be related to navigation or the navigation event.

On the other hand, when the decision 404 determines that the user input does not pertain to a navigation event, a decision 410 determines whether the user input pertains to a scroll event. When the decision 410 determines that the user input does pertain to a scroll event, the GUI (e.g., UI screen) can be updated 412 due to the scroll event. The GUI is presented on the display of the electronic device. In addition, audio feedback due to the scroll event can be output 414. The audio feedback being output 414 is provided with a tone frequency as was set 406 to relate to navigation or navigation input. Hence, in response to a scroll event, audio feedback provides not only an audio indication of the scroll event but also an audio indication by way of the tone frequency for the audio feedback to signal navigation information (e.g., menu position)

Alternatively, when the decision 410 determines that the user input is not a scroll event, other input processing can be performed 416. The other input processing can, for example, be for a selection event, a status request, an application/function activation, etc. Following the blocks 408, 414 and 416, the navigation/scroll input process 400 can return to repeat the decision 402 and subsequent blocks so that additional user inputs can be received and similarly processed.

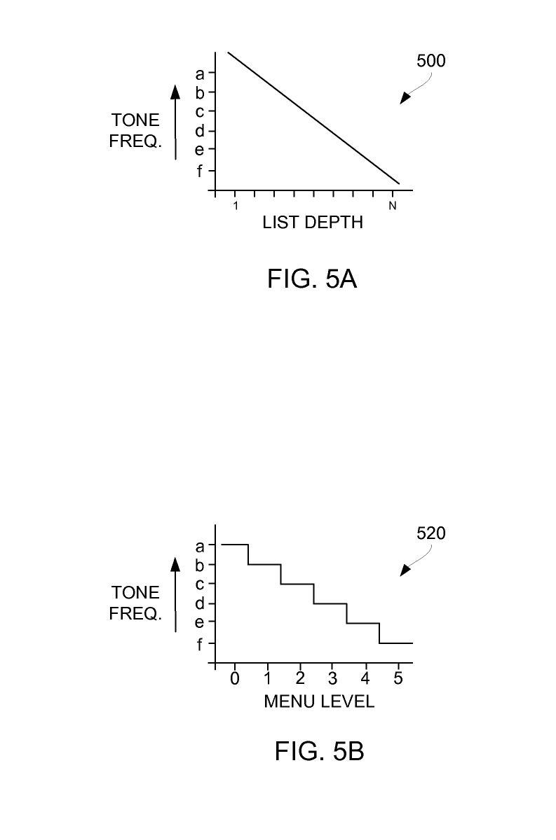

FIG. 5A is a graph 500 depicting an exemplary relationship of tone frequency to list depth according to one embodiment of the invention. The tone frequency pertains to the tone frequency utilized for audio feedback. Representative tones a, b, c, d, e and f represent different frequencies. In one embodiment, the representative tones a, b, c, d, e and f can correspond to notes of a scale. The list depth is the depth in a list to which a user has scrolled, such as by scrolling downward through the list. In this exemplary graph 500, the tone frequency for the audio feedback starts at a relatively high frequency and drops to lower frequencies as the user traverses the list in a downward direction. Although the graph 500 shows the tone frequency being linearly related to list depth, it should be noted that the relationship can be linear, non-linear and can be continuous or stepwise. As an example, the graph 500 can be used by block 310 of the scroll input process 300 to set the tone frequency for audio feedback based on list depth. As such the tone frequency for audio feedback of a scroll event can indicate to the user (by way of tone frequency) a depth within a list to which the user has scrolled.

FIG. 5B is a graph 520 depicting tone frequency with respect to menu level according to one embodiment of the invention. The tone frequency pertains to the tone frequency utilized for audio feedback. Representative tones a, b, c, d, e and f represent different frequencies. In one embodiment, the representative tones a, b, c, d, e and f can correspond to notes of a scale. The menu levels pertain to a hierarchical menu structure. In one implementation, as a user traverses downward into the hierarchical menu structure, the tone frequency utilized for audio feedback is lowered. In the graph 520, the tone frequency is lowered on a step basis, with each step pertaining to a different menu level associated with the hierarchical menu structure. Although the graph 520 shows the tone frequency being stepwise related to menu level, it should be noted that the relationship can be linear, non-linear and can be continuous or stepwise. As an example, the graph 520 can be used by block 406 of the navigation/scroll input process 300 to set the tone frequency for audio feedback based on menu level.

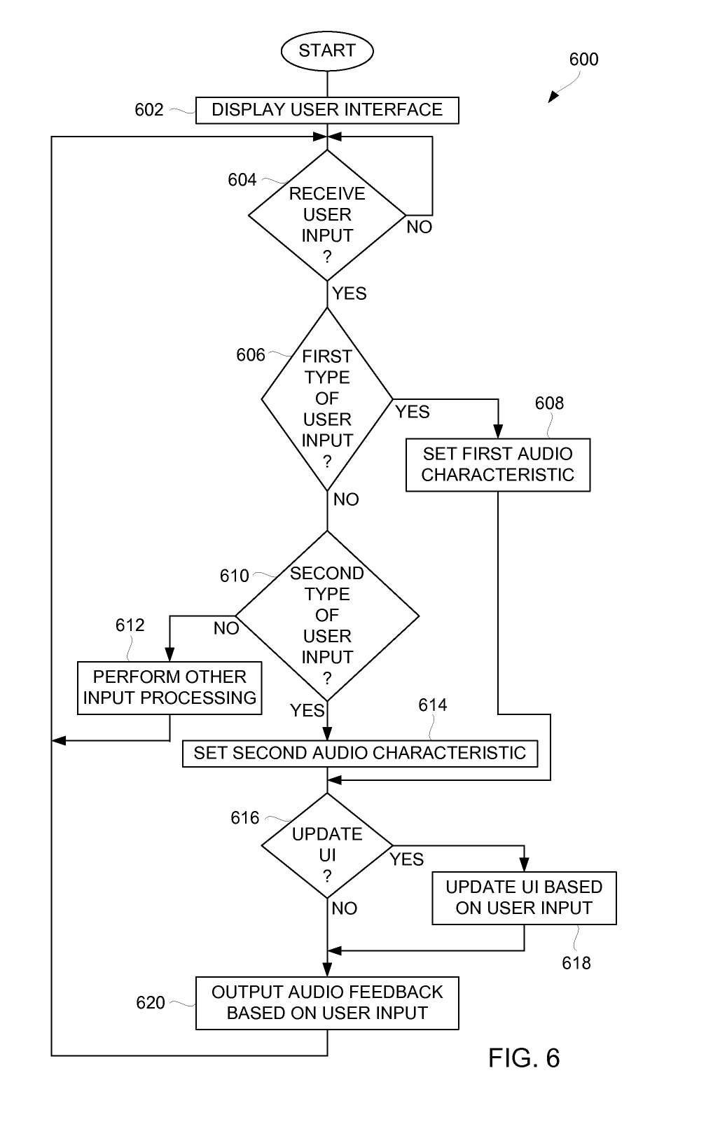

FIG. 6 is a flow diagram of an audio feedback process 600 according to one embodiment of the invention. The audio feedback process 600 is, for example, performed by an electronic device having a user input device and a display capable of presenting a graphical user interface (GUI). The electronic device is capable of providing audio feedback to a user.

The audio feedback process 600 displays 602 a user interface (e.g., graphical user interface). Next, a decision 604 determines whether a user input has been received. When the decision 604 determines that a user input has not been received, the audio feedback process 600 can await a user input. Once the decision 604 determines that a user input has been received, the audio feedback process 600 can continue. In other words, the audio feedback process 600 can be deemed to be invoked when a user input is received.

In any case, once a user input has been received, a decision 606 determines whether the user input is a first type of user input. When the decision 606 determines that the user input is a first type of user input, a first audio characteristic is set 608. Alternatively, when the decision 606 determines that the received user input is not a first type of user input, a decision 610 determines whether the received user input is a second type of user input. When the decision 610 determines that the received user input is not a second type of user input, then other input processing can be performed 612. The other input processing, if any, can be dependent on implementation.

On the other hand, when the decision 610 determines that the received user input is a second type of user input, a second audio characteristic is set 614. Following the block 614, as well as following the block 608, a decision 616 determines whether the user interface should be updated. When the decision 616 determines that the user interface should be updated, the user interface can be updated 618 based on the user input. Following the block 618, as well as directly following the decision 616 when the user interface is not to be updated, audio feedback is output 620 based on the user input. The audio feedback is produced in accordance with the first audio characteristic and the second audio characteristic. The nature of the first audio characteristic imposed on the audio feedback, as recognized by a user, serves to inform the user of the degree of the first type of user input that has been received. The nature of the second audio characteristic imposed on the audio feedback, as recognized by a user, serves to inform the user of the degree of the second type of user input that has been received. As one example, the first type of user input can be a menu navigation input and the second type of user input can be list traversal (e.g., scrolling). In such an example, the first audio characteristic can be loudness and the second audio characteristic can be frequency, or vice versa. In one implementation, the audio feedback can be output 620 from an audio output device (e.g., speaker) within the electronic device. Following the block 620, the audio feedback process 600 can return to repeat the decision 604 and subsequent blocks.

Another aspect of the invention makes use of audio feedback to provide a user with information concerning one or more conditions of an electronic device. The audio feedback can provide, for example, information to a user in an audio manner so that the user is able to understand the conditions of the electronic device without having to necessarily view the GUI. Examples of conditions of an electronic device that can be monitored to provide information to its user in an audio manner include, for example, battery status, network status, etc.

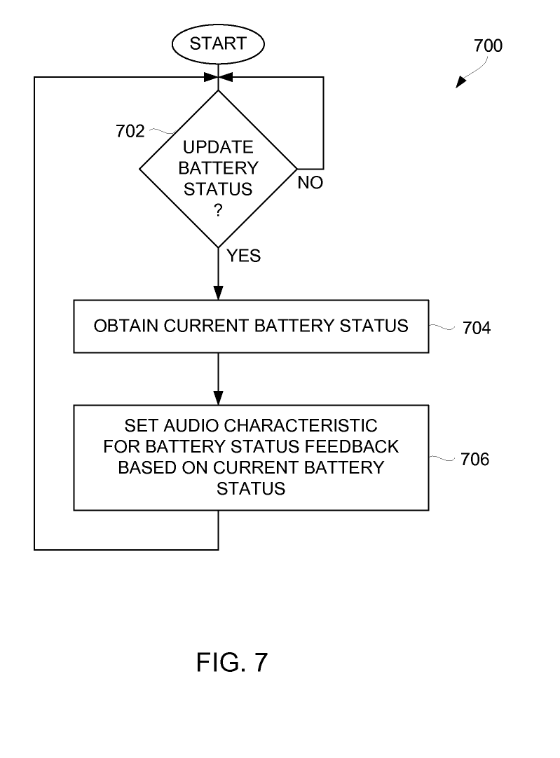

FIG. 7 is a flow diagram of an audio feedback process 700 according to one embodiment of the invention. The audio feedback process 700 is, for example, performed by an electronic device. The electronic device is primarily powered by a battery. The electronic device is capable of monitoring battery status.

The audio feedback process 700 begins with a decision 702. The decision 702 determines whether battery status should be updated at this time. When the decision 702 determines that battery status should not be updated at this time, the audio feedback process 700 awaits the appropriate time to update battery status. Once the decision 702 determines that battery status should be updated, the audio feedback process 700 continues. It should be noted that the battery status can pertain to one or more of: charge level, voltage level, current level, power level, temperature, etc. The battery status can also pertain whether or not the battery is being charged. With regard to charging, as one example, battery status can pertain to whether the battery is being charged from an AC power source. When the decision 702 determines that battery status is to be updated, current battery status is obtained 704. Then, one or more audio characteristics for battery status feedback are set 706 based on the current battery status. Following the block 706, the audio feedback process 700 can return to repeat the decision 702 so that the battery status can be subsequently updated.

The audio characteristics being utilized to signal one or more conditions of the electronic device can vary with implementation. For example, with the condition pertaining to battery status, the audio characteristic can be tone frequency that represents battery charge level. However, in general, the audio characteristic(s) can pertain to any characteristic that affects the audio output sound for the audio feedback. For example, the audio characteristic can pertain to: frequency, loudness, repetitions, duration, pitch, etc. Furthermore, although the audio feedback process 700 pertains to battery status, it should be noted that other conditions of the electronic device can alternatively or additionally be monitored and utilized to provide users information on such conditions via audio feedback. One example of another condition is network status (e.g., wireless network availability, strength, etc.).

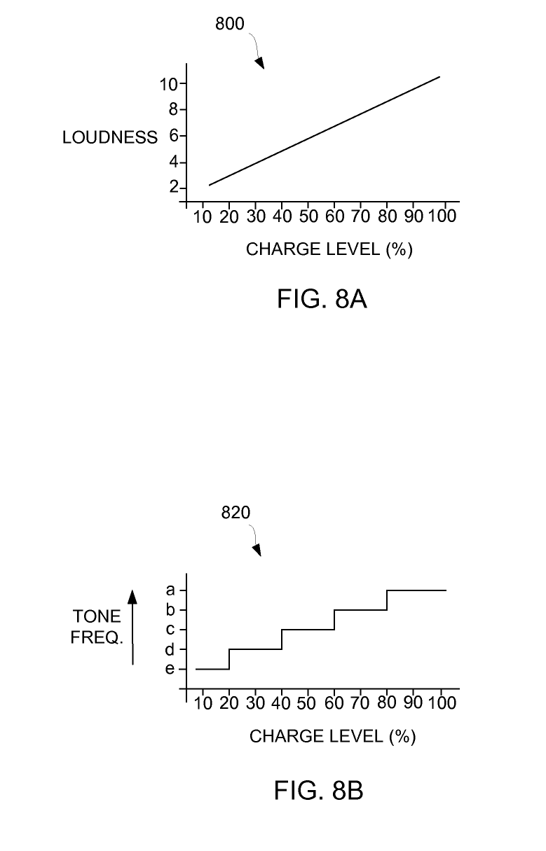

FIG. 8A is an exemplary graph 800 of loudness versus charge level according to one embodiment of the invention. The loudness pertains to the loudness (e.g., decibels (dB)) for the audio feedback associated with battery status. In particular, the battery status for the graph 800 pertains to charge level, as a percentage, of a fully charged battery. In this exemplary embodiment, the higher the charge level, the louder the audio feedback. Although the graph 800 shows the loudness being linearly related to charge level, it should be noted that the relationship can be linear, non-linear and can be continuous or stepwise.

FIG. 8B is a graph 820 of tone frequency versus charge level according to one embodiment of the invention. The tone frequency pertains to the tone frequency utilized for audio feedback. In this embodiment, the tone frequency pertains to a range of different frequencies for audio feedback pertaining to battery status. Representative tones a, b, c, d, e and f represent different frequencies. In one embodiment, the representative tones a, b, c, d, e and f can correspond to notes of a scale. The battery status for the graph 820 pertains to a charge level, as a percentage of being fully charged. In this exemplary embodiment, the higher the charge level, the higher the tone frequency for the audio feedback. Although the graph 820 shows the tone frequency being stepwise related to charge level, it should be noted that the relationship can be linear, non-linear and can be continuous or stepwise.

Still another aspect of the invention provides a user of an electronic device with audio feedback to not only assist with non-visual interaction with the electronic device but also indicate one or more conditions of the electronic device.

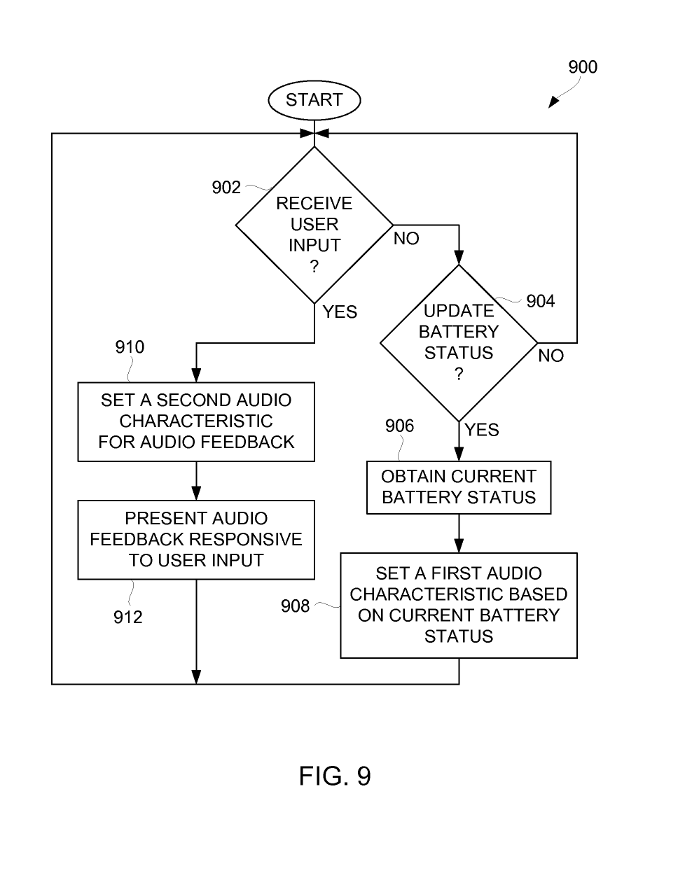

FIG. 9 is a flow diagram of an audio feedback process 900 according to one embodiment of the invention. The audio feedback process 900 is, for example, performed by an electronic device having a user input device and a display capable of presenting a graphical user interface (GUI). The electronic device is primarily powered by a battery. The electronic device is also capable of monitoring battery status and providing audio feedback to a user.

The audio feedback process 900 can begin with a decision 902. The decision 902 determines whether a user input has been received. When the decision 902 determines that a user input has not been received, a decision 904 determines whether a battery status pertaining to the battery should be updated. When the decision 904 determines that battery status should not be updated at this time, the audio feedback process 900 returns to repeat the decision 902. Alternatively, when the decision 904 determines that battery status is to be updated, a current battery status is obtained 906. A first audio characteristic can then be set 908 based on the current battery status.

On the other hand, when the decision 902 determines that a user input has been received, a second audio characteristic can be set for audio feedback. Here, depending on implementation, the second audio characteristic can be set 910 for audio feedback only when the user input is of a particular type. Next, audio feedback can be presented 912 in response to the user input. Following the block 908 or the block 912, the audio feedback process 900 can return to repeat the decision 902 and subsequent blocks so that additional user inputs can be processed and/or battery status updated.

In the embodiment of the audio feedback process 900, the battery status update is automatically performed. For example, the battery status could be updated on a periodic basis. Here, no user input is typically needed to trigger an update of battery status. A user of the electronic device can be informed of battery status by an audio output. In one implementation, the audio output can pertain primarily to audio feedback for a user input action (e.g., navigation, scroll) with respect to a user interface. The audio feedback can be modified in view of the battery status. The audio feedback can also be modified in view of the user input. As an example, a first audio characteristic of the audio feedback can correlate to battery status, and the second audio characteristic can correlate to user input. In one example, the first audio characteristic can be loudness and the second audio characteristic can be tone frequency. In another example, the first audio characteristic can be frequency tone and the second audio characteristic can be loudness.

Note that in one embodiment of the invention, the electronic device is a media player, such as a music player. When the media player is playing media for the benefit of its user, the audio output being produced to provide the user with user interaction and/or condition information can be mixed with any other audio output being provided by the media player. For example, if the media player is playing a song, the audio output for the battery status can be mixed with the audio output for the song. Additionally, for improved mixing, fade-in and fade-out techniques can be utilized. In one embodiment, the audio output (e.g., audio feedback and/or media playback) can be output using a speaker that is associated with the electronic device. For example, the speaker can be internal to the electronic device or external to the electronic device. Examples of an external speaker include a headset, headphone(s) or earphone(s) that can be coupled to the electronic device.

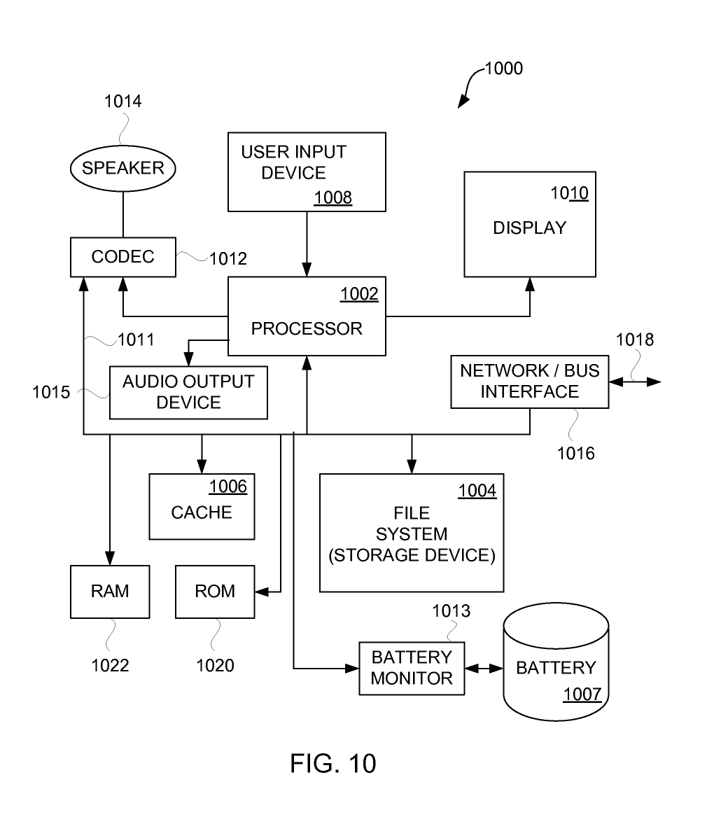

FIG. 10 is a block diagram of a media player 1000 according to one embodiment of the invention. The media player 1000 can perform the operations described above with reference to FIGS. 1-4, 6, 7 and 9.

The media player 1000 includes a processor 1002 that pertains to a microprocessor or controller for controlling the overall operation of the media player 1000. The media player 1000 stores media data pertaining to media items in a file system 1004 and a cache 1006. The file system 1004 is, typically, a storage device, such as a FLASH or EEPROM memory or a storage disk. The file system 1004 typically provides high capacity storage capability for the media player 1000. The file system 1004 can store not only media data but also non-media data (e.g., when operated as a storage device). However, since the access time to the file system 1004 is relatively slow, the media player 1000 can also include a cache 1006. The cache 1006 is, for example, Random-Access Memory (RAM) provided by semiconductor memory. The relative access time to the cache 1006 is substantially shorter than for the file system 1004. However, the cache 1006 does not have the large storage capacity of the file system 1004. Further, the file system 1004, when active, consumes more power than does the cache 1006. The power consumption is often a concern when the media player 1000 is a portable media player that is powered by a battery 1007. The media player 1000 also includes a RAM 1020 and a Read-Only Memory (ROM) 1022. The ROM 1022 can store programs, utilities or processes to be executed in a non-volatile manner. The RAM 1020 provides volatile data storage, such as for the cache 1006.

The media player 1000 also includes a user input device 1008 that allows a user of the media player 1000 to interact with the media player 1000. For example, the user input device 1008 can take a variety of forms, such as a button, keypad, dial, touch surface, etc. In one implementation, the user input device 1008 can be provided by a dial that physically rotates. In another implementation, the user input device 1008 can be implemented as a touchpad (i.e., a touch-sensitive surface). In still another implementation, the user input device 1008 can be implemented as a combination of one or more physical buttons as well as a touchpad. Still further, the media player 1000 includes a display 1010 (screen display) that can be controlled by the processor 1002 to display information to the user. A data bus 1011 can facilitate data transfer between at least the file system 1004, the cache 1006, the processor 1002, and the CODEC 1012.

The media player 1000 also provides condition (status) monitoring of one or more devices within the media player 1000. One device of the media player 1000 that can be monitored is the battery 1007. In this regard, the media player 1000 includes a battery monitor 1013. The battery monitor 1013 operatively couples to the battery 1007 to monitor its conditions. The battery monitor 1013 can communicate battery status (or conditions) with the processor 1002. The processor 1002 can cause an audio characteristic of audio feedback to be modified based on a condition of the battery 1007. Another device of the media player 1000 that could be monitored is the network/bus interface 1018, for example, to provide an audio indication of bus/network speed.

The processor 1002 can also cause one or more characteristics of audio feedback to be modified based on user interaction with the media player 1000. In any case, when audio feedback is triggered, the output of the audio feedback can be provided using an audio output device 715. As an example, the audio output device 715 can be a piezoelectric device (e.g., piezoelectric buzzer). The audio feedback is output in accordance with the one or more audio characteristics that have been modified. Although the audio feedback is output from the audio output device 715, in another embodiment, the audio feedback can be output from a speaker 1014.

In one embodiment, the media player 1000 serves to store a plurality of media items (e.g., songs) in the file system 1004. When a user desires to have the media player play a particular media item, a list of available media items is displayed on the display 1010. Then, using the user input device 1008, a user can select one of the available media items. Audio feedback can be provided as the user scrolls the list of available media items and/or as the user selects one of the available media items. The processor 1002, upon receiving a selection of a particular media item, supplies the media data (e.g., audio file) for the particular media item to a coder/decoder (CODEC) 1012. The CODEC 1012 then produces analog output signals for the speaker 1014. The speaker 1014 can be a speaker internal to the media player 1000 or external to the media player 1000. For example, headphones, headset or earphones that connect to the media player 1000 would be considered an external speaker. An external speaker can, for example, removably connect to the media player 1000 via a speaker jack.

In one implementation, the speaker 1014 can not only be used to output audio sounds pertaining to the media item being played, but also be used to provide audio feedback. When a particular device status is to be output to the speaker 1014, the associated audio data for the device status can be retrieved by the processor 1002 and supplied to the CODEC 1012 which then supplies audio signals to the speaker 1014. In the case where audio data for a media item is also being output, the processor 1002 can process the audio data for the media item as well as the device status. In such case, the audio feedback can be mixed with the audio data for the media item. The mixed audio data can then be supplied to the CODEC 1012 which supplies audio signals (pertaining to both the media item and the device status) to the speaker 1014.

The media player 1000 also includes a network/bus interface 1016 that couples to a data link 1018. The data link 1018 allows the media player 1000 to couple to a host computer. The data link 1018 can be provided over a wired connection or a wireless connection. In the case of a wireless connection, the network/bus interface 1016 can include a wireless transceiver.

In one embodiment, the media player 1000 can be a portable computing device dedicated to processing media such as audio and/or video. For example, the media player 1000 can be a music player (e.g., MP3 player), a video player, a game player, and the like. These devices are generally battery operated and highly portable so as to allow a user to listen to music, play games or video, record video or take pictures wherever the user travels. In one implementation, the media player 1000 is a handheld device that is sized for placement into a pocket or hand of the user. By being handheld, the media player 1000 is relatively small and easily handled and utilized by its user. By being pocket sized, the user does not have to directly carry the device and therefore the device can be taken almost anywhere the user travels (e.g., the user is not limited by carrying a large, bulky and often heavy device, as in a portable computer). Furthermore, the device may be operated by the user's hands, no reference surface such as a desktop is needed.

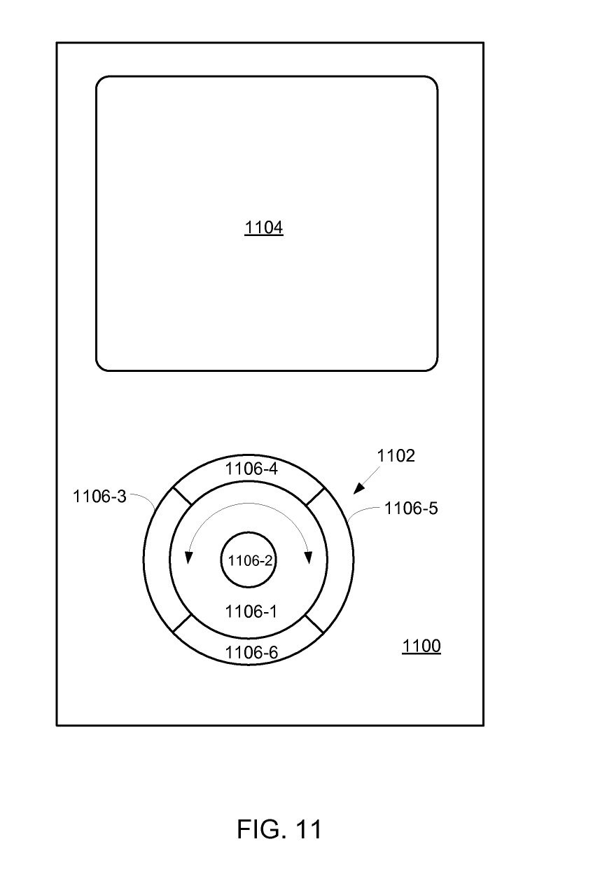

FIG. 11 illustrates a media player 1100 having a particular user input device 1102 according to one embodiment. The media player 1104 can also include a display 1104. The user input device 1102 includes a number of input devices 1106, which can be either physical or soft devices. One of the input devices 1106 can take the form of a rotational input device 1106-1 capable of receiving a rotational user input in either a clockwise or counterclockwise direction. The rotational input device 1106-1 can be implemented by a rotatable dial, such as in the form of a wheel, or a touch surface (e.g., touchpad). Another of the input device 1106 is an input device 1106-2 that can be provided at the center of the rotational input device 1106-1 and arranged to receive a user input event such as a press event. Other input devices 1106 include input devices 1106-3 through 1106-6 which are available to receive user supplied input action. The input devices 1106-2 through 1106-6 can be switches (e.g., buttons) or touch surfaces. The various input devices 1106 can be separate and integral to one another.

The invention is suitable for use with battery-powered electronic devices. However, the invention is particularly well suited for handheld electronic devices, such as a hand-held media device. One example of a handheld media device is a portable media player (e.g., music player or MP3 player). Another example of a handheld media device portable is a mobile telephone (e.g., cell phone) or Personal Digital Assistant (PDA).

One example of a media player is the iPod® media player, which is available from Apple Computer, Inc. of Cupertino, Calif. Often, a media player acquires its media assets from a host computer that serves to enable a user to manage media assets. As an example, the host computer can execute a media management application to utilize and manage media assets. One example of a media management application is iTunes®, produced by Apple Computer, Inc.

The various aspects, embodiments, implementations or features of the invention can be used separately or in any combination.

The invention is preferably implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that audio characteristics of audio feedback can be manipulated to provide information to a user. The information can pertain to interaction with a user interface for the electronic device. The information can also pertain to device condition information. Hence, when audio feedback is provided, one or more audio characteristics of the audio feedback can be manipulated to inform the user of user interface interaction and/or device condition information. As a result, a user can receive user interface interaction and/or device condition information without having to view a display screen or other visual indicator. This can be particularly useful when there is no display screen or other visual indicator, or when the user is busy and not able to conveniently view a visual indication. Another advantage of the invention is that the information provided to a user via audio characteristics can be automatically provided to the user whenever audio feedback is provided for other purposes. In effect, the information being provided by way of the audio characteristics can be considered to be indirectly provided to the user when audio feedback is provided.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for providing audio feedback to a user of an electronic device having a display and a user input device, said method comprising:
receiving a user input via the user input device;
setting at least one audio characteristic for audio feedback; and
presenting audio feedback responsive to the user input.

2. A method as recited in claim 1, wherein said setting of the audio characteristic is dependent on the type of user input.

3. A method as recited in claim 1, wherein said setting of the audio characteristic is dependent on the relative position with respect to a displayed user interface.

4. A method as recited in claim 1, wherein the electronic device is a portable electronic device having a battery, and
wherein said setting of the audio characteristic is dependent on at least one condition of the battery.

5. A method as recited in claim 1, wherein said setting comprises:
determining whether the user input is of a predetermined type of user input; and
modifying the audio characteristic when the user input is of the predetermined type.

6. A method as recited in claim 1, wherein said method further comprises:
determining whether the user input pertains to a graphical user interface (GUI) event, and
wherein said setting comprises modifying an audio characteristic based on a GUI event when said determining determines that the user input pertains to a graphical user interface event.

7. A method as recited in claim 1,
wherein the electronic device is a portable electronic device having a battery, and
wherein said setting comprises:
determining at least one condition of the battery;
modifying a first audio characteristic dependent on the at least one condition of the battery;
determining whether the user input is a predetermined user input; and
modifying a second audio characteristic when the user input is the predetermined user input.

8. A method as recited in claim 1, wherein said setting comprises:
determining whether the user input is of a first type of user input;
modifying a first audio characteristic when the user input is of the first type;
determining whether the user input is of a second type of user input; and
modifying a second audio characteristic when the user input is of the second type.

9. A method as recited in claim 8, wherein the first audio characteristic is frequency, and the second audio characteristic is loudness.

10. A method as recited in claim 8, wherein the first audio characteristic is loudness, and the second audio characteristic is frequency.

11. A method as recited in claim 1, wherein the display and the user input device are integral.

12. A method as recited in claim 1, wherein the audio characteristic is a frequency for the audio feedback.

13. A method as recited in claim 1, wherein the audio characteristic is loudness of the audio feedback.

14. A method as recited in claim 1, wherein said presenting of the audio feedback outputs an audio sound from a speaker.

15. A method as recited in claim 14, wherein the speaker is on or within the electronic device.

16. A method as recited in claim 15, wherein the speaker is a piezoelectric device.

17. A method as recited in claim 16, wherein the audio characteristic of the piezoelectric device is the loudness or frequency of the audio sound.

18. A method as recited in claim 14, wherein the speaker is external to the electronic device but in wired or wireless communication therewith.

19. A method as recited in claim 14, wherein the speaker is within a headset that operatively communicates with the electronic device.

20. A method as recited in claim 1, wherein the audio characteristic is one of frequency, loudness, duration or a number of repetitions for the audio feedback.

21. A method for providing audio feedback to a user of an electronic device having a display and a user input device, said method comprising:
receiving a user input pertaining to a menu navigation event with respect to a user interface presented on the display;
modifying an audio characteristic for audio feedback depending on the menu navigation event;
updating the user interface presented on the display based on the menu navigation event;
thereafter receiving a user input pertaining to a scroll event with respect to the user interface presented on the display;
updating the user interface presented on the display based on the scroll event; and
presenting audio feedback responsive to the user input pertaining to the scroll event, the audio feedback being presented in accordance with the audio characteristic.

22. A method as recited in claim 21,
wherein the electronic device is a portable electronic device having a battery,
wherein said modifying comprises:
modifying a first audio characteristic for audio feedback depending on a menu position of the user interface,
wherein said method further comprises:
determining at least one condition of the battery; and
modifying a second audio characteristic dependent on the at least one condition of the battery.

23. A method for providing audio feedback to a user of an electronic device having a display and a user input device, said method comprising:
receiving a user input pertaining to a scroll event with respect to a user interface presented on the display;
modifying an audio characteristic for audio feedback in response to the scroll event;
updating the user interface presented on the display based on the scroll event; and
presenting audio feedback responsive to the user input pertaining to the scroll event, the audio feedback being presented in accordance with the audio characteristic.

24. A method as recited in claim 23, wherein the audio characteristic is one of:
tone frequency, loudness, duration, or a number of repetitions.

25. A method as recited in claim 23,
wherein the electronic device is a portable electronic device having a battery,
wherein said modifying comprises:
modifying a first audio characteristic for audio feedback depending on the scroll event, and
wherein said method further comprises:
determining at least one condition of the battery; and
modifying a second audio characteristic dependent on the at least one condition of the battery.

26. A method for providing audio feedback to a user of an electronic device being powered by a battery, said method comprising:
obtaining battery status pertaining to the battery; and
setting an audio characteristic for battery status feedback based on the battery status.

27. A method as recited in claim 26, wherein the battery status is dependent on at least one condition of the battery.

28. A method as recited in claim 26, wherein the audio characteristic indicating the battery status is applied to other audio output.

29. A method as recited in claim 28, wherein the audio characteristic indicating the battery status is applied as an audio characteristic of the other audio output.

30. A method as recited in claim 29, wherein the audio characteristic is loudness, whereby the loudness of the other audio output signals the battery status to the user.

31. A method as recited in claim 29, wherein the audio characteristic is frequency, whereby the frequency of the other audio output signals the battery status to the user.

32. A method as recited in claim 29, wherein the electronic device has a user input device, and
wherein said method further comprises:
receiving a user input via the user input device;
setting an audio characteristic for audio feedback pertaining to the user input; and
presenting audio feedback responsive to the user input in accordance with the audio characteristic for the audio feedback pertaining to the user input.

33. A method as recited in claim 32, wherein said presenting further presents the audio feedback in accordance with the audio characteristic for battery status feedback.

34. A method as recited in claim 32, wherein said presenting produces audio feedback that is concurrently dependent on both the audio characteristic for the audio feedback pertaining to the user input and the audio characteristic for battery status feedback.

35. A computer readable medium including at least computer program code for providing audio feedback to a user of an electronic device having a display and a user input device, said computer readable medium comprising:
computer program code for receiving a user input via the user input device;
computer program code for setting at least one audio characteristic for audio feedback; and
computer program code for presenting audio feedback responsive to the user input.

36. A computer readable medium including at least computer program code for providing audio feedback to a user of an electronic device being powered by a battery, said computer readable medium comprising:
computer program code for obtaining battery status pertaining to the battery; and
computer program code for setting an audio characteristic for battery status feedback based on the battery status.

37. A portable media device, comprising:
an audio output device;
an electronic device used by said portable media player;
a monitor that monitors a condition of said portable media player; and
an audio feedback manager operatively connected to said monitor, said audio feedback manager causes an audio characteristic of audio feedback to be modified based on the condition of said portable media device, and determines when the audio feedback is to be output to said audio output device in accordance with the audio characteristic.

38. A portable media device as recited in claim 37, wherein the condition being monitored by said monitor pertains to said electronic device.

39. A portable media device as recited in claim 37,
wherein said portable media device further comprises a battery for supplying power to said portable media device, and
wherein the condition being monitored by said monitor pertains to status of said battery.

40. A portable media device as recited in claim 39, wherein the status of said battery is whether said battery is being charged.

41. A portable media device as recited in claim 39, wherein the status of said battery pertains to one or more of: charge level, voltage level, current level, power level and temperature.

42. A portable media device as recited in claim 37, wherein the condition being monitored pertains to a user interaction with respect to said portable media device.

43. A portable media device as recited in claim 37,
wherein said portable media device further comprises a processor, and
wherein said monitor and said audio feedback manager are integral with said processor.
